(19) United States
(12) Patent Application Publication
(10) Pub. No.: US 2024/0392134 A1
(43) Pub. Date: Nov. 28, 2024

(54) PROCESS FOR PREPARING A WET GROUND MINERAL MATERIAL

(71) Applicant: Omya International AG, Oftringen (CH)

(72) Inventors: Fabio IPPOLITO, Vordemwald (CH); Diane GAILLY, Saint Louis (FR)

(73) Assignee: Omya International AG, Oftringen (CH)

(21) Appl. No.: 18/690,972

(22) PCT Filed: Sep. 29, 2022
(86) PCT No.: PCT/EP2022/077136

§ 371 Date: Mar. 11, 2024

(30) Foreign Application Priority Data
Sep. 30, 2021 (EP) 21200137.4

(51) Int. Cl. C09C 3/04; B02C 23/18; C09C 1/02

(52) U.S. Cl. CPC C09C 3/041; B02C 23/18; C09C 1/021; C09C 1/028; C01P 2004/61; C01P 2004/62

(57) ABSTRACT

A process is provided for preparing a wet ground mineral material comprising the steps of: a) providing an aqueous suspension comprising a mineral material, wherein the aqueous suspension has a pH value of equal to or above 8.0; b) adding at least one hydroxide base to the aqueous suspension provided in step a); c) wet grinding the aqueous suspension during and/or after step b) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

### TECHNICAL FIELD OF INVENTION

The present invention relates to a process for preparing a wet ground mineral material as well as to the use of a wet grinding additive for reducing the specific grinding energy in wet grinding of mineral materials.

### BACKGROUND OF INVENTION

Aqueous preparations and especially suspensions of mineral materials such as calcium carbonate-containing materials are used extensively in agricultural and pharmaceutical applications as well as in the paper, paint, rubber and plastics industries as coatings, fillers, extenders and pigments for papermaking. For example, suspensions or slurries of calcium carbonate, talc or kaolin are used in the paper industry in large amounts as filler and/or as a component in the preparation of coated paper.

Typically, aqueous preparations of mineral materials are prepared by wet grinding mineral products in the presence of a dispersing agent. Such wet grinding processes require energy input. There is a continuous need in the art to reduce the energy input for wet grinding mineral materials as far as possible.

One object of the present invention is to provide an improved process for preparing wet ground mineral material, and particularly a process which requires less grinding energy input.

### SUMMARY OF THE INVENTION

One aspect of the present invention provides a process for preparing a wet ground mineral material. The process comprises the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension during and/or after step b) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

According to one particularly preferred embodiment of the present invention, a process is provided for preparing a wet ground mineral material, wherein the process comprises the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension during and/or after step b) to obtain an aqueous suspension comprising a wet ground mineral material, wherein the wet grinding is carried out in the presence of at least one dispersing agent, wherein the pH value of the aqueous suspension provided in step a) is increased in step b) to a value in the range of above 9.60 to 11.90, wherein the aqueous suspension obtained in step c) has a pH value which is at least 0.10 above the pH value of a comparative aqueous suspension which is obtained by the same process but without carrying out step b), and wherein the aqueous suspension obtained in step c) has a pH value of equal to or above 9.30.

Another aspect of the present invention provides a use of at least one hydroxide base as a wet grinding additive for reducing the specific grinding energy in wet grinding of an aqueous suspension comprising a mineral material and at least one dispersing agent.

The present invention is based on the finding that adding at least one hydroxide such as calcium hydroxide to a feed suspension of minerals, e.g. calcium carbonate-containing material, reduces the specific grinding energy which is required to subsequently wet grind the mineral suspension in the presence of at least one dispersing agent to a desired particle size distribution. The at least one hydroxide base is added in a manner that the mineral suspension obtained after wet grinding is at least 0.10 of pH higher than for a comparative process in which the at least one hydroxide base was not added, but under otherwise identical conditions. Thus, in the context of the invention, the at least one hydroxide base, e.g. calcium hydroxide, acts as a wet grinding additive (also referred to by the inventors as a “wet grinding booster”) for reducing the specific grinding energy that is needed to wet grind dispersed mineral material.

Preferred embodiments of the invention are defined in the dependent claims.

According to one embodiment of the invention, the mineral material is a magnesium carbonate- and/or calcium carbonate-containing material, and preferably a calcium carbonate-containing material having a calcium carbonate content of at least 50.0 wt. %, based on the total weight of the calcium carbonate-containing material.

According to one embodiment of the invention, the aqueous suspension provided in step a) has a solids content of at least 10.0 wt. %, preferably at least 50.0 wt. %, and more preferably at least 70.0 wt. %, and most preferably at least 75.0 wt. %, based on the total weight of the aqueous suspension.

According to one embodiment of the invention, the aqueous suspension provided in step a) comprises at least one dispersing agent which is present during the wet grinding step c).

According to one embodiment of the invention, the pH value of the aqueous suspension provided in step a) is increased in step b) to a value in the range of 9.70 to 11.60, and preferably 9.70 to 11.00.

According to one embodiment of the invention, the aqueous suspension obtained in step c) has a pH value which is at least 0.20, and preferably at least 0.30, above the pH value of a comparative aqueous suspension which is obtained by the same process but without carrying out step b).

According to one embodiment of the invention, the at least one hydroxide base added in step b) is at least one hydroxide of a mono-, di- or trivalent metal cation, and preferably is selected from the group consisting of lithium hydroxide, sodium hydroxide, potassium hydroxide, magnesium hydroxide, calcium hydroxide, and mixtures thereof.

According to one embodiment of the invention, the at least one hydroxide base added in step b) is calcium hydroxide, optionally in combination with another hydroxide base.

According to one embodiment of the invention, the at least one hydroxide base is added in step b) in an amount in the range of 25 to 1000 ppm, preferably in the range of 50 to 850 ppm, more preferably in the range of 50 to 750 ppm, and even more preferably 100 to 700 ppm, wherein “ppm” is defined as parts of at least one hydroxide base per million parts of dry mineral material.

According to one embodiment of the invention, the at least one dispersing agent is at least one ionic dispersing agent, preferably a polyelectrolyte dispersing agent, and more preferably a polyelectrolyte dispersing agent comprising a repeating unit bearing a carboxylate functional group.

According to one embodiment of the invention, the at least one dispersing agent is at least one polymer comprising a repeating unit derived from a monomer selected from the group consisting of acrylic acid, methacrylic acid, maleic acid, maleic anhydrides, and salts thereof, and preferably is a polymer or copolymer of acrylic acid or a polymer or copolymer of methacrylic acid.

According to one embodiment of the invention, the at least one dispersing agent is present in wet grinding step c) an amount of at least 0.1 wt. %, preferably of at least 0.2 wt. %, based on the total dry weight of the mineral material.

According to one embodiment of the invention, the at least one dispersing agent is added before, during and/or after step b), preferably before step b).

According to one embodiment of the invention, the wet ground mineral material obtained in step c) has a weight-median particle size d₅₀ in the range of 0.1 to 5.0 microns, and preferably 0.2 to 5.0 microns and/or a weight-based top cut particle size d₉₈ in the range of 0.5 to 20 microns, and preferably 1.0 to 20 microns.

For the present invention, the following terms have the following meanings:

The term “mineral material” is to be understood in a broad sense in that it covers synthetic minerals (e.g. precipitated calcium carbonate) or naturally occurring minerals (e.g. ground natural calcium carbonate).

The “particle size” of particulate materials herein is described by its distribution of particle sizes dₓ. Therein, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀ (wt.) unless indicated otherwise. Weight-based particle sizes can be determined by sedimentation analysis. For example, weight-based particle sizes may be determined by using a Sedigraph™ 5100 or 5120 instrument of Micromeritics Instrument Corporation. The method and the instrument are known to the skilled person and are commonly used to determine the particle size of fillers and pigments. The measurements may be carried out in an aqueous solution of 0.1 wt.-% Na₄P₂O₇.

Where the present description and claims define subject-matter “comprising” certain features, this is to be interpreted as meaning it includes those features, but that it does not exclude other non-specified features. For the purposes of the present invention, the term “essentially consisting of” and “consisting of” are considered to be specific embodiments of the term “comprising of”. If hereinafter a subject-matter is defined to comprise at least a certain number of features, this is also to be understood to disclose a subject-matter, which optionally (essentially) consists only of these features.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated. Terms like “obtainable” or “obtained” are used interchangeably. This means that, unless the context clearly dictates otherwise, the term “obtained” does not mean to indicate that, e.g., an embodiment must be obtained by, e.g., the sequence of steps following the term “obtained” even though such a limited understanding is always included by the terms “obtained” as a preferred embodiment.

### DETAILED DESCRIPTION OF THE INVENTION

### Process According to the Invention

One aspect of the present invention provides a process for preparing a wet ground mineral material. The process comprises the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension during and/or after step b) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

According to one particularly preferred embodiment of the present invention, a process is provided for preparing a wet ground mineral material, wherein the process comprises the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension during and/or after step b) to obtain an aqueous suspension comprising a wet ground mineral material, wherein the wet grinding is carried out in the presence of at least one dispersing agent, wherein the pH value of the aqueous suspension provided in step a) is increased in step b) to a value in the range of above 9.60 to 11.90, wherein the aqueous suspension obtained in step c) has a pH value which is at least 0.10 above the pH value of a comparative aqueous suspension which is obtained by the same process but without carrying out step b), and wherein the aqueous suspension obtained in step c) has a pH value of equal to or above 9.30.

### Step a)

In step a) of the process according to the invention, an aqueous suspension is provided comprising a mineral material, wherein the aqueous suspension has a pH value of equal to or above 8.0.

In principle, the mineral material may be any mineral material which is suitable for being provided in form of an aqueous suspension having a pH value of equal or above 8.0 and which is suitable for being wet ground.

Preferably, the mineral material is a magnesium carbonate- and/or calcium carbonate-containing material. The magnesium and/or calcium cations of the material may interact in the aqueous suspension with its environment, e.g. with a dispersing agent. According to one embodiment, the mineral material provided in step a) is a magnesium carbonate- and/or calcium carbonate-containing material. According to one embodiment, the mineral material provided in step a) is a magnesium carbonate-containing material. According to one embodiment, the mineral material provided in step a) is a magnesium carbonate- and calcium carbonate-containing material.

According to one preferred embodiment, the mineral material being present in the aqueous composition provided in step a) is a calcium carbonate-containing material.

The calcium carbonate-containing material may be a natural ground calcium carbonate, a precipitated calcium carbonate, or a mixture thereof.

In one embodiment, the calcium carbonate-containing material is a precipitated calcium carbonate. “Precipitated calcium carbonate” (PCC) in the meaning of the present invention is a synthesized material, generally obtained by precipitation following reaction of carbon dioxide and calcium hydroxide in an aqueous environment or by precipitation of calcium and carbonate ions, for example CaCl₂) and Na₂CO₃, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried.

According to one embodiment, the precipitated calcium carbonate is precipitated calcium carbonate, preferably comprising aragonitic, vateritic or calcitic mineralogical crystal forms or mixtures thereof.

In a preferred embodiment, the calcium carbonate-containing material is a natural ground calcium carbonate. In general, the natural ground calcium carbonate may be obtained, for example, in a wet and/or dry comminution step, such as crushing and/or grinding, from natural calcium carbonate-containing minerals (e.g. chalk, limestone, marble or dolomite). Preferably, the natural ground calcium carbonate is selected from the group consisting of chalk, limestone, marble, dolomite and mixtures thereof. In another preferred embodiment, the natural ground calcium carbonate is selected from the group consisting of chalk, limestone or marble. More preferably, the natural ground calcium carbonate is limestone or marble, and most preferably is marble.

According to one embodiment of the invention, the calcium carbonate-containing material has a calcium carbonate content of at least 50.0 wt. % (e.g. 50.0 to 99.8 wt. %), preferably at least 75.0 wt. % (e.g. 75.0 to 99.8 wt. %), more preferably at least 90.0 wt. % (e.g. 90.0 to 99.8 wt. %), and most preferably at least 95 wt.-% (e.g. 95.0 to 99.8 wt. %), based on the total weight of the calcium carbonate-containing material. According to one preferred embodiment, the calcium carbonate-containing material is a natural ground calcium carbonate (e.g. obtained from marble) having a calcium carbonate content of at least 75.0 wt. %, preferably at least 90.0 wt.-%, and most preferably at least 95.0 wt.-% (e.g. 95.0 to 99.8 wt. %), based on the total weight of the calcium carbonate-containing material.

The mineral material, preferably magnesium carbonate- and/or calcium carbonate-containing material, and more preferably calcium carbonate-containing material, being comprised in the aqueous suspension provided in step a) can have a specific particle size. The specific particle size may vary depending on the preparation process for the aqueous suspension provided in step a). For example, the aqueous suspension provided in step a) may be the product of a concentration (make down) of a slurry comprising a comparatively coarse mineral material which has not yet been subjected to a wet grinding step. In such case, the mineral material may be a dry ground or crushed mineral material.

Alternatively, the aqueous suspension provided in step a) may be the product of one or several wet fine grinding steps, e.g. the product of a first pass wet grinding step. In such case, the mineral material may have a finer particle size. Therefore, the specific particle size of the mineral material, preferably calcium carbonate-containing material, in the context of the present invention can vary within a comparatively broad range.

According to one embodiment, the mineral material, preferably the calcium carbonate-containing material, has a weight-median particle size d₅₀ in the range of 0.1 to 50 microns, preferably 0.5 to 25 microns, more preferably 0.5 to 20 microns, e.g. 1.0 to 15 microns or 1.0 to 12 microns.

According to one embodiment, the mineral material, preferably calcium carbonate-containing material, has a top cut weight particle size d₉₈ in the range of 0.5 to 200 microns, preferably 2.0 to 100 microns, more preferably 2.0 to 75 microns, e.g. 3.0 to 60 microns.

According to one embodiment, the mineral material, preferably the calcium carbonate-containing material, has a weight-median particle size d₅₀ in the range of 0.1 to 50 microns, preferably 0.5 to 25 microns, more preferably 0.5 to 20 microns (e.g. 1.0 to 15 microns or 1.0 to 12 microns), and a top cut weight particle size d₉₈ in the range of 0.5 to 200 microns, preferably 2.0 to 100 microns, more preferably 2.0 to 75 microns, e.g. 3.0 to 60 microns.

According to one embodiment, the mineral material, preferably the calcium carbonate-containing material, has (i) a calcium carbonate content of at least 50 wt. % (e.g. 50.0 to 99.8 wt. %), preferably at least 75 wt.-% (e.g. 75.0 to 99.8 wt. %), more preferably at least 90 wt.-% (e.g. 90.0 to 99.8 wt. %), (ii) a weight-median particle size d₅₀ in the range of 0.5 to 50 microns, preferably 0.5 to 25 microns, more preferably 0.5 to 20 microns (e.g. 1.0 to 15 microns or 1.0 to 12 microns), and (iii) a top cut weight particle size d₉₈ in the range of 1.5 to 200 microns, preferably 2.0 to 100 microns, more preferably 2.0 to 75 microns, e.g. 3.0 to 60 microns.

The mineral material may be a coarse mineral material. According to one embodiment, the mineral material, preferably the calcium carbonate-containing material, has a weight-median particle size d₅₀ in the range of 2.0 to 50 microns, preferably 5.0 to 25 microns (e.g. 5.0 to 15 microns), and a top cut weight particle size d₉₈ in the range of 20 to 200 microns, preferably 30 to 100 microns (e.g. 40 to 75 microns).

Alternatively, the mineral material may be a fine mineral material. According to one embodiment, the mineral material, preferably the calcium carbonate-containing material, has a weight-median particle size d₅₀ in the range of 0.1 to 10 microns, preferably 0.5 to 5.0 microns (e.g. 0.5 to 2.5 microns), and a top cut weight particle size d₉₈ in the range of 0.5 to 20 microns, preferably 1.5 to 15 microns (e.g. 2.0 to 10 microns).

The aqueous suspension provided in step a) has a pH value of equal to or above 8.0, e.g. from 8.0 to 9.90. In one preferred embodiment, the aqueous suspension provided in step a) has a pH value from equal to or above 8.50 (e.g. from 8.50 to below 9.70, and more preferably of equal to or above 9.0, e.g. from 9.0 to 9.60, e.g. from 9.0 to 9.50, e.g. from 9.20 to 9.50).

A skilled person knows how to measure the pH value of an aqueous suspension. Preferably, the pH value as defined in this specification are measured at a temperature of 25° C. (+/−1° C.) using a pH meter, e.g. as described in the examples.

The aqueous suspension provided in step a) can have a specific solid content. The solid content may be dependent on the particle size of the mineral material. For example, if the mineral material has an ultra fine particle size, the solid content of the aqueous suspension provided in step a) may be lower. In case the mineral material has a fine or coarse particle size, the solid content of the aqueous suspension is usually much higher.

According to one embodiment, the aqueous suspension provided in step a) has a solids content of at least 10.0 wt. %, preferably at least 50.0 wt. %, more preferably at least 70.0 wt. % (e.g. between 70.0 and 85.0 wt. %), and most preferably at least 75.0 wt. %, based on the total weight of the aqueous suspension.

As will be defined in detail herein below under step c) of the process according to the invention, wet grinding step c) is carried out in the presence of at least one dispersing agent. Depending on the selected order of process steps, the aqueous suspension provided in step a) can comprise one or all of the at least one dispersing agents being present in step c).

According to one preferred embodiment, the aqueous suspension provided in step a) comprises at least one dispersing agent (e.g. one or two dispersing agents) being present during the wet grinding step c). The number of dispersing agents that are present in the aqueous suspension can depend on the particle size of the mineral material, preferably the calcium carbonate-containing material, and the process for preparing the aqueous suspension provided in step a). For example, if the mineral material is a comparatively coarse material which has not been subject to a previous wet grinding step, the aqueous suspension can comprise one dispersing agent. If the mineral material is a material which has already been subject to a previous wet grinding step, the aqueous suspension can comprise more than one dispersing agent (e.g. two dispersing agents). The at least one dispersing agent is further defined herein below under step c).

Alternatively, the aqueous suspension provided in step a) does not contain a dispersing agent. In this alternative, the at least one dispersing agent, being present in step c) of the process, has to be added during and/or after step b).

In principle, it is possible that the aqueous suspension comprises further components in addition to the mineral material, and the optional at least one dispersing agent. According to one embodiment, the aqueous suspension comprises further components, e.g. additives (e.g. defoamers), in addition to the mineral material, and the optional at least one dispersing agent.

It is however also possible, and usually preferred, that the aqueous suspension does not comprise further components other than the mineral material, and the optional at least one dispersing agent. Thus, according to one embodiment, the aqueous suspension provided in step a) essentially consists of (or consists of) water, the mineral material and the optionally at least one dispersing agent.

According to one preferred embodiment, an aqueous composition is provided in step a) having a pH value of above 8.50 and a solids content of at least 70.0 wt. %, based on the total weight of the aqueous suspension,
wherein the aqueous composition comprises
a calcium carbonate-containing material having
(i) a calcium carbonate content of at least 90.0 wt. % (e.g. 90.0 to 99.8 wt. %) based on the total weight of the calcium containing material,
(ii) a weight-median particle size d₅₀ in the range of 0.5 to 20 microns (e.g. 1.0 to 15 microns or 1.0 to 12 microns), and
(iii) a top cut weight particle size d₉₈ in the range of 2.0 to 100 microns (e.g. 3.0 to 75 microns), and
at least one dispersing agent, preferably as defined herein below under step c).

### Step b)

In step b) of the inventive process, at least one hydroxide base is added to the aqueous suspension provided in step a).

In addition to the surprising and advantageous effects described herein above, the inventors further found that the specific grinding energy can be further reduced by increasing the pH value in step b) to a value in a specific pH range or by a specific delta (i.e. a specific difference of pH before and after the pH value increase).

According to one preferred embodiment, the pH value of the aqueous suspension is increased in step b) to a value in the range of above 9.60 to 11.90, preferably 9.70 to 11.60 (e.g. in the range of 9.70 to 11.00, 9.70 to 10.80, 9.70 to 10.60, 9.80 to 11.00, 9.80 to 10.80, 9.80 to 10.60, 9.90 to 11.00, 9.90 to 10.80 or 9.90 to 10.60), more preferably 9.7 to 11.00, and most preferably 10.0 to 10.80 (e.g. 10.30 to 10.80). This embodiment is to be understood in that the pH value in the defined range is either achieved before the wet grinding step c) or during the wet grinding step c), preferably before the wet grinding step c), i.e. the pH value is preferably the pH value of the feed of wet grinding step c).

By adding the at least one hydroxide base to the aqueous suspension provided in step a) the pH value of the suspension provided in step a) may be increased. According to one embodiment, the pH value of the suspension provided in step a) is increased in step b) by at least 0.2, preferably at least 0.30, more preferably at least 0.40, and even more preferably by at least 0.50 (e.g. a value in the range of 0.50 to 2.50).

It is possible to add one or more than one hydroxide bases in step b). In one specific embodiment, one hydroxide base is added in step b).

According to one embodiment, the at least one hydroxide base added in step b) is at least one (e.g. one to three) hydroxide of a mono-, di- or trivalent cation, preferably of a mono-, di- or trivalent metal cation. It is preferred that the at least one hydroxide base is an inorganic compound.

According to one preferred embodiment, the at least one hydroxide base is selected from the group consisting of lithium hydroxide, sodium hydroxide, potassium hydroxide, magnesium hydroxide, calcium hydroxide, and mixtures thereof, preferably from the group consisting of sodium hydroxide, magnesium hydroxide, calcium hydroxide and mixtures thereof, and more preferably from the group consisting of sodium hydroxide, magnesium hydroxide, calcium hydroxide and mixtures thereof.

It is preferred that the at least one hydroxide base is at least one hydroxide base of a mono- or divalent metal cation, and optionally is at least one hydroxide base of a divalent metal cation.

A particularly preferred hydroxide base to be added in step b) of the inventive process is calcium hydroxide. The calcium hydroxide may be added in step b) as the only hydroxide base or in combination with another hydroxide base. Thus, according to one preferred embodiment of the invention, the at least one hydroxide base added in step b) is calcium hydroxide, optionally in combination with another hydroxide base. According to one preferred embodiment, the at least one hydroxide base added in step b) is calcium hydroxide. The inventors surprisingly found that calcium hydroxide used as wet grinding additive leads to a specifically pronounced reduction of specific grinding energy compared to a process which does not use calcium hydroxide as wet grinding additive under otherwise identical conditions.

The at least one hydroxide base is added in step b) in an amount to achieve the effect of increasing the pH value of the aqueous suspension obtained in step c) by at least 0.10, compared to a comparative aqueous suspension which is obtained by the same process but without carrying out step b), i.e. which is obtained by the same process but without adding the at least one hydroxide base. The amount may vary depending on the basicity and the molecular weight of the at least one hydroxide base, the nature of the mineral material and dispersing agent(s), and the final particle size distribution of the ground mineral material.

According to one preferred embodiment of the invention, the at least one hydroxide base is added in step b) in an amount in the range of 25 to 1000 ppm, preferably in the range of 50 to 850 ppm, more preferably in the range of 50 to 750 ppm, and most preferably in the range of 100 to 700 ppm (e.g. in the range of 100 to 400 ppm). In this context, “ppm” means parts of hydroxide base per million parts of dry mineral material (e.g. dry calcium carbonate-containing material).

The at least one hydroxide base may be added in step b) in dry form (e.g. in form of pellets or a powder) or as part of an aqueous composition (e.g. solution or suspension). It is preferred that the at least one hydroxide base is added as part of an aqueous composition. The inventors found that addition of an aqueous suspension comprising the at least one hydroxide base, preferably calcium hydroxide, allows for improving the processability of the aqueous suspension obtained in step b).

According to one embodiment, the at least one hydroxide base is added in step b) in form of an aqueous composition comprising the at least one hydroxide base in an amount in the range of 0.1 to 45.0 wt. % (e.g. 0.1 to 30 wt. % or 0.1 to 20 wt. %), and preferably 2.0 to 10.0 wt. % (e.g. 2.0 to 6.0 wt. % or 3.0 to 5.0 wt. %), based on the total weight of the aqueous composition.

As will be defined in detail herein below under step c), step b) can be carried out before and/or during wet grinding step c).

In one embodiment, step b) is carried out before the wet grinding according to step b). In one embodiment, step b) is carried out before the wet grinding step c), and the pH value of the aqueous suspension (i.e. the feed for step c)) is increased in step b) to a value in the range of above 9.60 to 11.90, preferably 9.70 to 11.60, more preferably 10.00 to 11.00 (e.g. in the range of 10.20 to 10.80), and most preferably 10.30 to 10.80.

In one embodiment, step b) is carried out before and during the wet grinding according to step b).

In one embodiment, step b) is carried out during the wet grinding according to step b).

According to one embodiment, at least one hydroxide base is added to the aqueous suspension provided in step a), wherein the at least one hydroxide base is at least one hydroxide of a mono-, di- or trivalent metal cation, preferably is selected from the group consisting of lithium hydroxide, sodium hydroxide, potassium hydroxide, magnesium hydroxide, calcium hydroxide, and mixtures thereof, and more preferably is selected from the group consisting of sodium hydroxide, magnesium hydroxide, calcium hydroxide and mixtures thereof, and
wherein the pH value of the aqueous suspension is increased in step b) to a value in the range of 9.70 to 11.90.

### Step c)

In step c) of the process according to the invention, the aqueous suspension is wet ground during and/or after step b) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

Thus, the comparative aqueous suspension is obtained by carrying out the identical mandatory and optional steps as the process according to one embodiment of the invention (e.g. using the same aqueous suspension provided in step a), using the same conditions for grinding step c), using the same at least one dispersing agent, etc.) with the exception that no at least one hydroxide base is added before and/or during wet grinding step c). It is further to be understood that the point in time of measuring the pH value of the aqueous suspension obtained in step c) of the inventive process and the aqueous suspension obtained by the comparative process is about the same or is the same. The point in time of measuring the pH value of the aqueous suspension obtained in step c) and the aqueous suspension obtained by the comparative process may be less than 24 hours after carrying out wet grinding step c), preferably is less than 4 hours, most preferably is less than 2 hours after carrying out wet grinding step c), and optionally is immediately measured after carrying out wet grinding step c) and cooling the slurry down to 25° C.

According to one embodiment, the aqueous suspension obtained in step c) has a pH value which is at least 0.20 (e.g. from 0.20 to 2.00, e.g. from 0.20 to 1.50), preferably at least 0.30 (e.g. from 0.30 to 2.00, e.g. from 0.30 to 1.50), and more preferably at least 0.35 (e.g. from 0.35 to 2.00, e.g. from 0.35 to 1.50), above the pH value of a comparative aqueous suspension which is obtained by the same process but without carrying out step b). According to one embodiment, the aqueous suspension obtained in step c) has a pH value which is at least 0.50 (e.g. from 0.50 to 2.00, e.g. from 0.20 to 1.50) above the pH value of a comparative aqueous suspension which is obtained by the same process but without carrying out step b).

The aqueous suspension obtained in step c) of the inventive process preferably has a pH value in a specific range. According to one preferred embodiment, the aqueous suspension obtained in step c) has a pH value of equal to or above 9.30 (e.g. from 9.30 to 11.00), more preferably of equal to or above 9.40 (e.g. in the range of from 9.40 to 11.00), even more preferably of equal to or above 9.50 (e.g. from 9.50 to 11.00), optionally of equal to or above 10.00 (e.g. from 10.00 to 11.00).

In general, wet grinding step c) can be carried out with any conventional grinding device known in the art for wet grinding aqueous suspensions comprising a mineral material, preferably a calcium carbonate-containing material.

For example, the wet grinding step c) can be carried out with any conventional grinding device under conditions such that refinement predominantly results from impacts with a secondary body, i.e. in one or more of a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled person. The grinding step may also be performed under conditions such that autogenous grinding takes place, and/or other such processes known to the skilled person.

Wet grinding step c) may be carried out in a vertical or horizontal ball mill, preferably in a vertical ball mill. Such vertical and horizontal ball mills usually consist of a vertically or horizontally arranged, cylindrical grinding chamber comprising an axially fast rotating agitator shaft being equipped with a plurality of paddles and/or stirring discs, such as described for example in EP 0 607 840 A1.

According to one preferred embodiment, wet grinding step c) is carried out in the presence of grinding media. The grinding media can be selected by the person skilled in the art.

The wet grinding step c) may be carried out with any specific grinding energy which is suitable for achieving the target particle size of the wet ground mineral material. For example, the specific grinding energy may be in the range of 10 to 200 kWh/T (dry solids), 20 to 150 kWh/T (dry solids), 30 to 100 kWh/T (dry solids), or 40 to 80 kWh/T (dry solids).

As set out herein above, it is believed that the addition of the at least one hydroxide base (“wet grinding booster”) improves the grinding efficiency of the at least one dispersing agent on the mineral material which in turn allows the dispersion to be ground using less energy. In view thereof, the order of steps for adding the at least one hydroxide base to the aqueous suspension and for wet grinding the aqueous suspension is not specifically restricted as long as the at least one dispersing agent and the at least one hydroxide base are allowed to interact at some point before and/or during the wet grinding step. It is however preferred that the addition of the at least one hydroxide base according to step b) is completed before the wet grinding step c) is carried out.

According to one embodiment, wet grinding step c) is carried out during the addition of the at least one hydroxide base according to step b).

According to another embodiment, wet grinding step c) is carried out during and after the addition of at least one hydroxide base according to step b).

According to yet another embodiment, wet grinding step c) is carried out after the addition of the at least one hydroxide base according to step b). According to one preferred embodiment, wet grinding step c) is carried out after step b).

Wet grinding step c) is carried out in the presence of at least one dispersing agent (e.g. one to three dispersing agents). Thus, the aqueous suspension obtained in step c) also comprises at least one dispersing agent in addition to the wet ground mineral material.

According to one preferred embodiment, the at least one dispersing agent is at least one ionic dispersing agent, preferably at least one anionic dispersing agent. An “ionic dispersing agent” in the meaning of the present invention is a dispersing agent which comprises an ionizable or ionic functional group (e.g. carboxylic acid, carboxylate, etc.).

The at least one dispersing agent may be a non-polymeric ionic dispersing agent. Suitable non-polymeric ionic dispersing agents are, but not limited to, pyrophosphates (e.g. sodium pyrophosphate) and hydroxy-carboxylic acids (e.g. citrates, tartrates, succinates etc.).

The at least one dispersing agent may also be a polyelectrolyte dispersing agent. A “polyelectrolyte dispersing agent” in the meaning of the invention is a polymeric dispersing agent having at least one repeating unit which bears an ionizable or ionic functional group (e.g. carboxylic acid, carboxylate, sulfonic acid, etc.). Suitable polyelectrolyte dispersing agents are, but not limited to, polymers and copolymers of acrylic acid and methacrylic acid, and polyphosphates.

According to one preferred embodiment of the present invention, the at least one dispersing agent is at least one polyelectrolyte dispersing agent, and preferably an anionic polyelectrolyte dispersing agent. According to one preferred embodiment, the at least one dispersing agent is at least one polyelectrolyte dispersing agent comprising a repeating unit bearing a carboxylate functional group, and optionally a repeating unit bearing an alcohol functional group and/or a repeating unit bearing an ester functional group. According to one preferred embodiment, the at least one dispersing agent is at least one polyelectrolyte dispersing agent consisting of at least one repeating unit bearing a carboxylate functional groups, and optionally at least one repeating unit bearing an alcohol functional group and/or at least one repeating unit bearing an ester functional group.

According to one preferred embodiment of the present invention, the at least one dispersing agent is at least one polymer comprising a repeating unit derived a monomer selected from the group consisting of acrylic acid, methacrylic acid, maleic acid, maleic anhydrides, and salts thereof.

Preferably, the at least one dispersing agent is a homopolymer or copolymer of acrylic acid or a homopolymer or copolymer of methacrylic acid. Suitable copolymers are selected from the group of copolymers of acrylic acid and vinyl acetates and/or its hydrolyzed products (e.g. vinyl alcohol), copolymers of acrylic acid and acrylates (i.e. esters of acrylic acid), copolymers of acrylic acid and maleic acid or its anhydride, copolymers of methacrylic acid and vinyl acetates and/or its hydrolyzed products (e.g. vinyl alcohol), copolymers of methacrylic acid and acrylates (i.e. esters of acrylic acid), copolymers of methacrylic acid and maleic acid or its anhydride, and salts of those copolymers.

According to one preferred embodiment, the at least one dispersing agent is at least one homopolymer of acrylic acid.

The weight average molecular weight (Mw) of the polyelectrolyte dispersing agent may vary. According to one embodiment, the at least one dispersing agent may be a polyelectrolyte dispersing agent having a weight average molecular weight Mw in the range of 1000 g/mol to 15000 g/mol, preferably 2000 to 10000 g/mol, and more preferably 3000 to 8000 g/mol. According to one preferred embodiment, the at least one dispersing agent is at least one polymer or copolymer of acrylic acid or methacrylic acid, preferably of acrylic acid, having a weight average molecular weight Mw in the range of 1000 g/mol to 15000 g/mol, preferably 2000 to 10000 g/mol, and more preferably 3000 to 8000 g/mol.

The at least one ionic dispersing agent, preferably polyelectrolyte dispersing agent, may be partially or fully neutralized by one or more neutralizing agents. The one or more neutralizing agents may be selected from the group consisting of mono-, di- and multivalent cations, e.g. Na⁺, Ca²⁺ and mixtures thereof.

Preferably, the at least one ionic dispersing agent, preferably polyelectrolyte dispersing agent, is fully neutralized by one or more neutralizing agents, which are selected from the group of mono-, di- and multivalent cations.

The at least one dispersing agent can be used in any amount which is suitable to achieve a dispersing effect on the mineral material, preferably the calcium carbonate-containing material. As will be understood by those skilled in the art, the amount of the dispersing agent being present in wet grinding step c) may vary depending on the particle size of the feed mineral material (i.e. aqueous suspension provided in step a)) and the method of preparation of the feed mineral material. For example, if the feed mineral material is the product of a previous grinding step, it may be necessary or desirable to add further dispersing agent for grinding step c) which may accumulate to a higher amount of dispersing agent. Alternatively, the feed mineral material may not have been the subject to previous wet grinding but may be the product of a slurry makedown. In such case, the amount of dispersing agent which is present during wet grinding step c) may be less.

According to one preferred embodiment, the at least one dispersing agent is present in wet grinding step c) an amount of at least 0.1 wt. % (e.g. from 0.1 to 2 wt. %), preferably from 0.15 wt. % (e.g. 0.15 to 1.5 wt. %), more preferably of at least 0.2 wt. % (e.g. from 0.2 to 1.5 wt. %), and even more preferably in an amount in the range of 0.2 to 1.0 wt. %, based on the total dry weight of the mineral material.

The at least one dispersing agent may principally be added at any time during the process as long as at least one dispersing agent is present during the wet grinding step c). According to one embodiment, the at least one dispersing agent is added before, during and/or after the pH adjustment of step b). According to one preferred embodiment, the at least one dispersing agent is added before the pH adjustment in step b).

According to one preferred embodiment, the process comprises the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension after step b) (i.e. the aqueous suspension obtained in step b)) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

According to one more preferred embodiment, the process comprises the steps of:
a) providing an aqueous suspension comprising a mineral material, wherein the aqueous suspension has a pH value of equal to or above 8.0;
b) adding at least one hydroxide base to the aqueous suspension provided in step a), wherein the pH value of the aqueous suspension provided in step a) is increased in step b) to a value in the range of above 9.60 to 11.90;
c) wet grinding the aqueous suspension after step b) (i.e. the aqueous suspension obtained in step b)) to obtain an aqueous suspension comprising a wet ground mineral material, wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b), and wherein the aqueous suspension obtained in step c) has a pH value of equal or above 9.30.

It is a requirement of the invention that at least one dispersing agent is present during wet grinding step c). The number of dispersing agents which are present during wet grinding step c) can depend on the method of preparation of the aqueous suspension provided in step a). For example, if the aqueous suspension provided in step a) is the product of a previous wet grinding step, the suspension provided in step a) may comprise a dispersing agent. In such case, it is possible, and sometimes preferred, to add a second dispersing agent for the subsequent wet grinding carried out in step c) of the inventive process. According to one embodiment, one dispersing agent is present during wet grinding step c). According to another embodiment, two or more dispersing agents (e.g. two or three) are present during wet grinding step c).

The wet grinding step c) may be the first wet grinding step to which the mineral material provided in step a) is subjected (“first pass wet grinding”). It is however also possible that the wet grinding step c) is the second (or third, fourth etc.) wet grinding step, to which the mineral material provided in step a) is subjected (“second pass wet grinding”). According to one embodiment, the wet grinding step c) is a first pass wet grinding step or a second pass grinding step.

According to one embodiment, the process according to the invention comprises the steps of:
a) providing an aqueous suspension comprising a mineral material, preferably a magnesium carbonate- and/or calcium carbonate-containing material, wherein the aqueous suspension has a pH value of equal to or above 8.0, preferably in the range of above 8.5 (e.g. 9.0 to 9.6);
b) adding at least one hydroxide base, preferably at least one hydroxide base of a mono-, di- or trivalent metal cation, to the aqueous suspension provided in step a);
c) first pass wet grinding the aqueous suspension during and/or after step b), preferably after step b) to obtain an aqueous suspension comprising a wet ground mineral material, wherein the wet grinding is carried out in the presence of at least one dispersing agent, preferably at least one polyelectrolyte dispersing agent comprising carboxylate-functional groups, and wherein the aqueous suspension obtained in step c) has a pH value which is at least 0.10 above the pH value of a comparative aqueous suspension which is obtained by the same process but without carrying out step b);
d) second pass wet grinding the aqueous suspension obtained in step c), wherein optionally one or more additional dispersing agents and/or one or more additional hydroxide base are added before and/or during step d).

According to one embodiment, the process according to the invention comprises the steps of:
a) providing an aqueous suspension comprising a mineral material, preferably a magnesium carbonate- and/or calcium carbonate-containing material, wherein the aqueous suspension has a pH value of equal to or above 8.0, preferably in the range of above 8.5 (e.g. 9.0 to 9.6);
b) adding at least one hydroxide base, preferably at least one hydroxide base of a mono-, di- or trivalent metal cation, to the aqueous suspension provided in step a), wherein the pH value of the aqueous suspension provided in step a) is increased in step b) to a value in the range of above 9.60 to 11.90;
c) first pass wet grinding the aqueous suspension during and/or after step b), preferably after step b) to obtain an aqueous suspension comprising a wet ground mineral material, wherein the wet grinding is carried out in the presence of at least one dispersing agent, preferably at least one polyelectrolyte dispersing agent comprising carboxylate-functional groups, and wherein the aqueous suspension obtained in step c) has a pH value which is at least 0.10 above the pH value of a comparative aqueous suspension which is obtained by the same process but without carrying out step b), and wherein the aqueous suspension obtained in step c) has a pH value of equal to or above 9.30;
d) second pass wet grinding the aqueous suspension obtained in step c), wherein optionally one or more additional dispersing agents and/or one or more additional hydroxide base are added before and/or during step d).

According to another embodiment, the process according to the invention comprises the steps of:
a) providing an aqueous suspension comprising a mineral material, preferably a magnesium carbonate- and/or calcium carbonate-containing material, wherein the aqueous suspension has a pH value of equal to or above 8.0, and preferably of above 8.5, wherein step a) comprises the steps of:
   i) providing an aqueous suspension comprising a mineral material, preferably a magnesium carbonate- and/or calcium carbonate-containing material, wherein the aqueous suspension has a pH value of equal to or above 8.0 (e.g. 9.0 to 9.6);
   ii) first pass wet grinding the aqueous suspension, wherein the first pass wet grinding is carried out in the presence of at least one dispersing agent, preferably at least one polyelectrolyte dispersing agent, wherein the aqueous suspension obtained in step ii) has a pH value of equal to or above 8.0;
b) adding at least one hydroxide base, preferably at least one hydroxide base of a mono-, di- or trivalent metal cation, to the aqueous suspension provided in step a);
c) second pass wet grinding the aqueous suspension during and/or after step b) to obtain an aqueous suspension comprising a wet ground mineral material, and wherein the aqueous suspension obtained in step b) has a pH value which is at least 0.10 above the pH value of a comparative aqueous suspension which is obtained by the same process but without carrying out step b),
   wherein optionally one or more additional dispersing agents are added before and/or during step c).

According to another embodiment, the process according to the invention comprises the steps of:
a) providing an aqueous suspension comprising a mineral material, preferably a magnesium carbonate- and/or calcium carbonate-containing material, wherein the aqueous suspension has a pH value of equal to or above 8.0, and preferably of above 8.5, wherein step a) comprises the steps of:
   i) providing an aqueous suspension comprising a mineral material, preferably a magnesium carbonate- and/or calcium carbonate-containing material, wherein the aqueous suspension has a pH value of equal to or above 8.0 (e.g. 9.0 to 9.6);
   ii) first pass wet grinding the aqueous suspension, wherein the first pass wet grinding is carried out in the presence of at least one dispersing agent, preferably at least one polyelectrolyte dispersing agent, wherein the aqueous suspension obtained in step ii) has a pH value of equal to or above 8.0;
b) adding at least one hydroxide base, preferably at least one hydroxide base of a mono-, di- or trivalent metal cation, to the aqueous suspension provided in step a), wherein the pH value of the aqueous suspension provided in step a) is increased in step b) to a value in the range of above 9.60 to 11.90;
c) second pass wet grinding the aqueous suspension during and/or after step b) to obtain an aqueous suspension comprising a wet ground mineral material, and wherein the aqueous suspension obtained in step b) has a pH value which is at least 0.10 above the pH value of a comparative aqueous suspension which is obtained by the same process but without carrying out step b),
wherein the aqueous suspension obtained in step c) has a pH value of equal to or above 9.30; and
wherein optionally one or more additional dispersing agents are added before and/or during step c).

The physical properties of the wet ground mineral material obtained in step c) and/or the aqueous suspension comprising the wet ground mineral material obtained in step c) may vary, e.g. depending on the desired particle size or previous process steps.

The wet ground mineral material obtained in step c) may be defined by its particle size.

According to one embodiment, the wet ground mineral material obtained in step c) has a weight-median particle size d₅₀ in the range of 0.1 to 5.0 microns, and preferably 0.2 to 5.0 microns. According to one embodiment, the wet ground mineral material obtained in step c) has a weight-based top cut particle size d₉₈ in the range of 0.5 to 20 microns, and preferably 1.0 to 20 microns. According to one embodiment, the wet ground mineral material obtained in step c) has a weight-median particle size d₅₀ in the range of 0.1 to 5.0 microns, and preferably 0.2 to 5.0 microns. and a weight-based top cut particle size des in the range of 0.5 to 20 microns, and preferably 1.0 to 20 microns.

According to one embodiment, the wet ground mineral material obtained in step c) has a weight-median particle size d₅₀ in the range of 0.1 to 2.0 microns, and preferably 0.2 to 1.0 (e.g. 0.2 to 0.75) microns. According to one embodiment, the wet ground mineral material obtained in step c) has a weight-based top cut particle size d₉₈ in the range of 0.5 to 5.0 microns, and preferably 1.0 to 3.5 microns. According to one embodiment, the wet ground mineral material obtained in step c) has a weight-median particle size d₅₀ in the range of 0.1 to 2.0 microns, and preferably 0.2 to 1.0 microns, and a weight-based top cut particle size d₉₈ in the range of 0.5 to 5.0 microns, and preferably 1.0 to 3.5 (e.g. 1.0 to 2.5) microns.

According to one embodiment, the wet ground mineral material obtained in step c) has a weight-median particle size d₅₀ in the range of 1.0 to 5.0 microns, and preferably 1.2 to 5.0 (e.g. 1.2 to 3.5) microns. According to one embodiment, the wet ground mineral material obtained in step c) has a weight-based top cut particle size d₉₈ in the range of 2.0 to 20 microns (e.g. 2.0 to 15 microns). According to one embodiment, the wet ground mineral material obtained in step c) has a weight-median particle size d₅₀ in the range of 1.0 to 5.0 microns, and preferably 1.2 to 5.0 (e.g. 1.2 to 3.5) microns, and a weight-based top cut particle size d₉₈ in the range of 2.0 to 20 microns (e.g. 2.0 to 15 microns).

The aqueous suspension obtained in step c) may be defined by its viscosity.

According to one embodiment, the aqueous suspension obtained in step c) has a Brookfield viscosity in the range of 50 to 500 mPa*s, preferably 100 to 400 mPa*s, determined at a rotation speed of 100 rpm for 1 min and at 25° C. (+/−1° C.).

According to one embodiment, the aqueous suspension obtained in step c) has a Brookfield viscosity in the range of equal to or above 125 mPa*s, preferably in the range of 125 to 200 mPa*s or in the range of 250 to 400 mPa*s, determined at a rotation speed of 100 rpm for 1 min and at 25° C. (+/−1° C.), and the wet ground mineral material has a weight-median particle size d₅₀ in the range of 0.1 to 2.0 microns, and preferably 0.2 to 1.0 (e.g. 0.2 to 0.75) microns, and a weight-based top cut particle size d₉₈ in the range of 0.5 to 5.0 microns, and preferably 1.0 to 3.5 microns.

According to one embodiment, the aqueous suspension obtained in step c) has a Brookfield viscosity in the range of 50 to 125 mPa*s, determined at a rotation speed of 100 rpm for 1 min and at 25° C. (+/−1° C.), and the wet ground mineral material has a weight-median particle size d₅₀ in the range of 1.0 to 5.0 microns, and preferably 1.2 to 5.0 (e.g. 1.2 to 3.5) microns, and a weight-based top cut particle size d₉₈ in the range of 2.0 to 20 microns (e.g. 2.0 to 15 microns).

The aqueous suspension may also be defined by a combination of its particle size and its pH value.

According to one embodiment, the aqueous suspension obtained in step c) has a pH value in the range of 9.30 to 11.00, and the wet ground mineral material has a weight-median particle size d₅₀ in the range of 0.1 to 2.0 microns, and preferably 0.2 to 1.0 (e.g. 0.2 to 0.75) microns, and a weight-based top cut particle size d₉₈ in the range of 0.5 to 5.0 microns, and preferably 1.0 to 3.5 microns.

According to one embodiment, the aqueous suspension obtained in step c) has a pH value in the range of 9.60 to 11.00, and comprises a wet ground mineral material having a weight-median particle size d₅₀ in the range of 1.0 to 5.0 microns, and preferably 1.2 to 5.0 (e.g. 1.2 to 3.5) microns, and a weight-based top cut particle size d₉₈ in the range of 2.0 to 20 microns (e.g. 2.0 to 15 microns).

The process according to the invention can comprise one or more additional process steps known to the skilled person such as classifying steps, additional wet grinding steps, addition of additives (e.g. stabilizers, rheology modifiers, biocides, etc), etc.

In one aspect of the present invention, a product is provided which is obtained or obtainable by the process according to the invention.

### Use According to the Invention

Another aspect of the present invention relates to the use of at least one hydroxide base as a wet grinding additive for reducing the specific grinding energy in wet grinding of an aqueous suspension comprising a mineral material and at least one dispersing agent.

“Specific grinding energy” (SGE) is a parameter which is well known by a person of skill, and can be determined according to the common knowledge. The specific grinding energy defines the grinding energy which is needed to grind a specific amount of feed material (e.g. slurry) of a defined particle size distribution and solid content to a product material having a desired particle size distribution and solid content.

The specific grinding energy is indicated herein as kWh/T, wherein T is the metric tons of dry solids in the aqueous suspension subjected to the wet grinding process.

In principle, the specific grinding energy may be determined as follows:

$$S G E = \frac{Power}{Feed density \cdot Feed flow \cdot Feed solid content} ,$$

wherein the “feed flow” is the volumetric feed flow.

The specific grinding energy may be calculated by equation (I):

$$S G E = \frac{P \cdot 1000}{{M}_{dryTot}} , \qquad ( I )$$

wherein P is the power input (in kW) and M_{dryTot} is the total dry mass of mineral material feed through in 1 hour (in kg/h).

M_{dryTot} can be calculated by equation (II):

$${M}_{dryTot} = {M}_{dryL} \cdot F F , \qquad ( II )$$

wherein M_{dryL} is the total dry mass of mineral material per liter of aqueous suspension (in kg/L) and FF is feed flow of aqueous suspension (in L/h).

M_{dryL} may be calculated by equation (III):

$${M}_{dryL} = \frac{ρ \cdot S C}{100} , \qquad ( III )$$

wherein ρ is the density of the aqueous suspension (in kg/L) and SC is the solid content of the aqueous suspension (in % mass).

Density ρ can be calculated by equation (IV):

$$ρ = \frac{1}{1 - \frac{( {d}_{dry} - 1 ) \cdot S C}{{d}_{dry} \cdot 100}} \cdot {ρ}_{{H}_{2} O} , \qquad ( IV )$$

wherein d_{dry} is the dry mineral material relative density, SC is the solid content of the aqueous suspension (in % mass) and ρ_{H2O} is the density of the reference material water, which equals 1 kg/L.

The specific grinding energy may be calculated by equation (V):

$$S G E = \frac{P \cdot {10}^{5}}{F F \cdot S C \cdot {ρ}_{{H}_{2} O}} \cdot ( 1 - \frac{( {d}_{dry} - 1 ) \cdot S C}{{d}_{dry} \cdot 100} ) , \qquad ( V )$$

wherein
P is the power input (in kW), FF is the feed flow of the aqueous suspension (in L/h), SC is the solid content of the aqueous suspension (in % mass), ρ_{H2O} is the density of the reference material water (equal to 1 kg/L) and d_{dry} is the dry mineral material relative density.

The reduction of the specific grinding energy is determined in comparison to the wet grinding of an aqueous suspension comprising a mineral material and at least one dispersing agent, wherein no at least one hydroxide base is used as wet grinding additive under otherwise identical conditions.

According to one embodiment, the specific grinding energy is reduced by at least 2%, preferably at least 4%, and more preferably from 4 to 25% (e.g. 6 to 25%, 6 to 20%, 8 to 25%, 8 to 20%, 10 to 25%, or 10 to 20%).

A “wet grinding additive” is to be understood as an additive, which is added to an aqueous suspension before and/or during a wet grinding step.

For the definition of the mineral material (chemical and physical properties, amounts, etc.), the at least one hydroxide base (chemical and physical properties, amounts, etc.) and the at least one dispersing agent (chemical and physical properties, amounts, etc.), it is referred to the embodiments and preferred embodiments as defined herein above in the context of the process according to the invention, and to the dependent claims.

Some embodiments and preferred embodiments of the inventive use are defined herein below to further illustrate the invention. It is however to be understood that other embodiments, which are defined herein above in the context of the process according to the invention, may also be combined with the aspect and the embodiments of the use according to the invention.

One embodiment of the invention provides the use of at least one hydroxide base as a wet grinding additive for reducing the specific grinding energy in wet grinding of an aqueous suspension comprising a mineral material and at least one dispersing agent,
wherein the at least one hydroxide base is at least one hydroxide of a mono-, di- or trivalent metal cation, preferably the at least one hydroxide base is selected from the group consisting of lithium hydroxide, sodium hydroxide, potassium hydroxide, magnesium hydroxide, calcium hydroxide, and mixtures thereof, more preferably the at least one hydroxide base is selected from the group consisting of sodium hydroxide, magnesium hydroxide, calcium hydroxide, and mixtures thereof, and even more preferably is calcium hydroxide, optionally in combination with one or more additional hydroxide bases,
wherein the aqueous suspension has a solids content of at least 70 wt. % (e.g. 70 to 85 wt. %), preferably at least 75 wt. % (e.g. 75 to 85 wt. %), based on the total weight of the aqueous suspension,
wherein the mineral material is a calcium carbonate-containing material, preferably having a calcium carbonate content of at least 90 wt. % (e.g. 90 to 99.8 wt. %), more preferably at least 95 wt. % (e.g. 90 to 99.8 wt. %), and
wherein the at least one dispersing agent is at least one polyelectrolyte dispersing agent.

One embodiment of the invention provides the use of at least one hydroxide base as a wet grinding additive for reducing the specific grinding energy in wet grinding of an aqueous suspension comprising a mineral material and at least one dispersing agent,
wherein the at least one hydroxide base is at least one hydroxide of a mono-, di- or trivalent metal cation, preferably the at least one hydroxide base is selected from the group consisting of lithium hydroxide, sodium hydroxide, potassium hydroxide, magnesium hydroxide, calcium hydroxide, and mixtures thereof, more preferably the at least one hydroxide base is selected from the group consisting of sodium hydroxide, magnesium hydroxide, calcium hydroxide, and mixtures thereof, and even more preferably is calcium hydroxide, optionally in combination with one or more additional hydroxide bases,
wherein the at least one hydroxide base is used in an amount in the range of 25 to 1000 μm, preferably in the range of 50 to 850 ppm, more preferably in the range of 50 to 750 ppm, and even more preferably 100 to 700 ppm,
wherein the aqueous suspension has a solids content of at least 70 wt. % (e.g. 70 to 85 wt. %), preferably at least 75 wt. % (e.g. 75 to 85 wt. %), based on the total weight of the aqueous suspension,
wherein the mineral material is a calcium carbonate-containing material, preferably having a calcium carbonate content of at least 90 wt. % (e.g. 90 to 99.8 wt. %), more preferably at least 95 wt. % (e.g. 90 to 99.8 wt. %),
wherein the at least one dispersing agent is at least one polyelectrolyte dispersing agent, and
wherein the at least one dispersing agent is present in the wet grinding step an amount of at least 0.1 wt. % (e.g. 0.1 to 2 wt. %), preferably of at least 0.2 wt. % (e.g. 0.2 to 2 wt. %), based on the total dry weight of the mineral material.

One embodiment of the invention provides the use of at least one hydroxide base as a wet grinding additive for reducing the specific grinding energy in wet grinding of an aqueous suspension comprising a mineral material and at least one dispersing agent,
wherein the at least one hydroxide base is calcium hydroxide,
wherein the at least one hydroxide base is used in an amount in the range of 25 to 1000 μm, preferably in the range of 50 to 850 ppm, more preferably in the range of 50 to 750 ppm, and even more preferably 100 to 700 ppm,
wherein the aqueous suspension has a solids content of at least 70 wt. % (e.g. 70 to 85 wt. %), preferably at least 75 wt. % (e.g. 75 to 85 wt. %), based on the total weight of the aqueous suspension,
wherein the mineral material is a calcium carbonate-containing material, preferably having a calcium carbonate content of at least 90 wt. % (e.g. 90 to 99.8 wt. %), more preferably at least 95 wt. % (e.g. 90 to 99.8 wt. %),
wherein the at least one dispersing agent is at least one polymer or copolymer of acrylic acid or methacrylic acid, and
wherein the at least one dispersing agent is present in the wet grinding step an amount of at least 0.1 wt. % (e.g. 0.1 to 2 wt. %), preferably of at least 0.2 wt. % (e.g. 0.2 to 2 wt. %), based on the total dry weight of the mineral material.

Further non-limiting aspects and embodiments of the present invention are defined in the following numbered clauses:

[1] A process for preparing a wet ground mineral material comprising the steps of:
a) providing an aqueous suspension comprising a mineral material, wherein the aqueous suspension has a pH value of equal or above 8.0;
b) adding at least one hydroxide base to the aqueous suspension provided in step a);
c) wet grinding the aqueous suspension during and/or after step b) to obtain an aqueous suspension comprising a wet ground mineral material,
wherein the wet grinding is carried out in the presence of at least one dispersing agent, and wherein the aqueous suspension obtained in step c) has a pH value which is at least 0.10 above the pH value of a comparative aqueous suspension which is obtained by the same process but without carrying out step b).

[2] The process according to embodiment [1], wherein the mineral material is a magnesium carbonate- and/or calcium carbonate-containing material, and preferably a calcium carbonate-containing material having a calcium carbonate content of at least 50.0 wt. %, based on the total weight of the calcium carbonate-containing material.

[3] The process according to embodiment [1] or [2], wherein the aqueous suspension provided in step a) has a solids content of at least 10.0 wt. %, preferably at least 50.0 wt. %, and more preferably at least 70.0 wt. %, and most preferably at least 75.0 wt. %, based on the total weight of the aqueous suspension.

[4] The process according to any one of embodiments [1] to [3], wherein the aqueous suspension provided in step a) comprises at least one dispersing agent which is present during the wet grinding step c).

[5] The process according to any one of embodiments [1] to [4], wherein the pH value of the aqueous suspension provided in step a) is increased in step b) to a value in the range of above 9.60 to 11.90, preferably 9.70 to 11.60, and more preferably 9.70 to 11.00.

[6] The process according to any one of embodiments [1] to [5], wherein the aqueous suspension obtained in step c) has a pH value which is at least 0.20, and preferably at least 0.30, above the pH value of a comparative aqueous suspension which is obtained by the same process but without carrying out step b), and/or wherein the aqueous suspension obtained in step c) has a pH value of above 9.30.

[7] The process according to any one of embodiments [1] to [6], wherein the at least one hydroxide base added in step b) is at least one hydroxide of a mono-, di- or trivalent metal cation, and preferably is selected from the group consisting of lithium hydroxide, sodium hydroxide, potassium hydroxide, magnesium hydroxide, calcium hydroxide, aluminum hydroxide, and mixtures thereof.

[8] The process according to any one of embodiments [1] to [7], wherein the at least one hydroxide base added in step b) is calcium hydroxide, optionally in combination with another hydroxide base.

[9] The process according to any one of embodiments [1] to [8], wherein the at least one hydroxide base is added in step b) in an amount in the range of 25 to 1000 ppm, preferably 50 to 750 ppm, and more preferably 100 to 400 ppm, wherein “ppm” is defined as parts of at least one hydroxide base per million parts of dry mineral material.

[10] The process according to any one of embodiments [1] to [9], wherein the at least one dispersing agent is at least one ionic dispersing agent, preferably a polyelectrolyte dispersing agent, and more preferably a polyelectrolyte dispersing agent comprising a repeating unit bearing a carboxylate functional group.

[11] The process according to any one of embodiments [1] to [10], wherein the at least one dispersing agent is at least one polymer comprising a repeating unit derived from a monomer selected from the group consisting of acrylic acid, methacrylic acid, maleic acid, maleic anhydrides, and salts thereof, and preferably is a polymer or copolymer of acrylic acid or a polymer or copolymer of methacrylic acid.

[12] The process according to any one of embodiments [1] to [11], wherein the at least one dispersing agent is present in wet grinding step c) an amount of at least 0.1 wt. %, preferably of at least 0.2 wt. %, based on the total dry weight of the mineral material.

[13] The process according to any one of embodiments [1] to [12], wherein the at least one dispersing agent is added before, during and/or after step b), preferably before step b).

[14] The process according to any one of embodiments [1] to [13], wherein the wet ground mineral material obtained in step c) has a weight-median particle size d₅₀ in the range of 0.1 to 5.0 microns, and preferably 0.2 to 5.0 microns and/or a weight-based top cut particle size d₉₈ in the range of 0.5 to 20 microns, and preferably 1.0 to 20 microns.

[15] Use of at least one hydroxide base as a wet grinding additive for reducing the specific grinding energy in wet grinding of an aqueous suspension comprising a mineral material and at least one dispersing agent.

In the following, the present invention is further illustrated by means of specific examples, which are not to be understood as limiting the invention in any way.

### Examples Section

### A. Measurement Methods

The following measurement methods are used to evaluate the parameters given in the examples and claims.

### pH Measurement

Any pH value was measured at 25° C. (+/−1° C.) using a Mettler-Toledo Seven Easy pH meter and a Mettler-Toledo InLab Routine Pro pH electrode. A two point calibration (according to the segment method) of the instrument was first made using commercially available buffer solutions having pH values of 7 and 10 at 25° C. (from Mettler). The reported pH values were the endpoint values detected by the instrument (signal differs by less than 0.1 mV from the average over the last 6 seconds). Any sample measured was manually stirred for 10 seconds directly before pH-measurement.

### Conductivity Measurement

Conductivity of a suspension was measured at 25° C. (+/−1° C.) using Cond 315i instrumentation from WTW equipped with the corresponding WTW Tetracon 325 conductivity probe, directly following manual stirring of the suspension for 10 seconds. The influence of temperature on conductivity was automatically corrected by the nonlinear correction mode. Measured conductivities were reported for the reference temperature of 25° C. The reported conductivity values were the endpoint values detected by the instrument (the endpoint is when the measured conductivity differs by less than 0.5% from the average over the last 10 seconds and temperature differs by less than 0.3° C. over the last 15 seconds).

### Particle Size Distribution and Weight Median Grain Diameter

Particle size distribution (mass % particles with a diameter<X) and weight median grain diameter (d₅₀) of particulate materials were determined via the sedimentation method, i.e. an analysis of sedimentation behaviour in a gravimetric field. The measurement was made with a Sedigraph™ 5100 at 25° C. (+/−1° C.). The method and the instrument are known to the skilled person and are commonly used to determine grain size of fillers and minerals. The measurement was carried out in an aqueous solution of 0.1% by weight of Na₄P₂O₇. The samples were dispersed using a high speed stirrer and ultrasonic bath.

### Viscosity Measurement

Brookfield viscosity was measured after 1 minute (if no other indication) of stirring by the use of a DV-E model Brookfield™ viscometer at a rotation speed of 100 rpm (revolutions per minute) with the appropriate disc spindle 3 or 4. Without further indication the viscosity was measured at 25° C. (+/−1° C.). Samples were initially measured right after the stabilisation step after a quick restirring for 10 seconds, then left to rest. Viscosities were remeasured after 7 days without restirring the sample prior to the measurement, and again after 14 days, once prior restirring and once after stirring the sample manually for 2 min.

### Weight Solids (% by Weight) of a Material in Suspension

Weight solids was determined by dividing the weight of the solid material by the total weight of the aqueous suspension. The weight of the solid material was determined by weighing the solid material obtained by evaporating the aqueous phase of suspension and drying the obtained material to a constant weight.

### B. Materials

### Mineral Material

The following calcium carbonate-containing material A was used as mineral material for test trials 1-23:

Natural CaCO₃ marble from Italy, Avenza, having a d₉₈ value of 50 μm, a d₅₀ value of 10 μm, and a d₂₀ value of 2 μm.

The following calcium carbonate-containing material B was used as mineral material for test trials 24-26:

Natural CaCO₃ limestone from Austria, Gummern, having a d₉₈ value of 18 μm, a d₅₀ value of 5 μm, and a d₂₀ value of 1.5 μm.

### Dispersing Agents

Dispersing agents used for the test trials are described in the following table 1.

TABLE 1
Dispersing agents

| Dispersing | | Mw | Neutralization |
|---|---|---|---|
| agent | Composition | [g/mol] | [mol %] |
| A | Homopolymer of acrylic acid | 6000 | 70% Na⁺, |
| | | | 30% Ca²⁺ |
| B | Homopolymer of acrylic acid | 7000 | 50% Na⁺ |
| | | | 50% Ca²⁺ |
| C | Homopolymer of acrylic acid | 7000 | 100% Na⁺ |
| D | Homopolymer of acrylic acid | 4000 | 100% Na⁺ |

### Hydroxide Bases (Wet Grinding Additive)

Hydroxide bases used as wet grinding additives according to the invention are described in the following table 2:

TABLE 2
Hydroxide bases

| | Chemical | | |
|---|---|---|---|
| Name | formula | Trademark | Purity |
| Sodium hydroxide | NaOH | GPR RECTAPUR (VWR) | >98% |
| Calcium hydroxide | Ca(OH)₂ | HYGIACAL ® 80 (ECL) | >93% |
| Magnesium hydroxide | Mg(OH)₂ | Magnifin H10 (Huber | >95% |
| | | Martinswerk) | |

### C. Test Results

### 1. Trials 1 to 6

### First Pass Wet Grinding

An aqueous suspension having solids content of 76 wt.-% (+/−1 wt.-%), based on the total weight of the suspension, was prepared by mixing tap water with 3000 ppm of dispersing agent A, the calcium carbonate-containing material A using a Ystral mixer (Dispermix, Ystral GmbH, Germany), and then 300 ppm of Ca(OH) 2 was optionally added as wet grinding additive. The Ca(OH) 2 was added so as to have a homogenous pH increase throughout the aqueous suspension.

Subsequently, the obtained mixture was wet ground in a 200-litre vertical attritor mill using zircon silicate beads of 0.7 to 1.4 mm diameter. The slurry temperature at the mill inlet was 20° C. and at the outlet between 9° and 100° C. The mill parameters where adjusted in order to reach a particle size distribution of at least 60%<2 μm. Results for this step are shown in tables 3A and 3B below.

TABLE 3A
Wet grinding of an aqueous suspension comprising calcium carbonate-containing
material A in the presence or absence of Ca(OH)₂ as wet grinding additive

| | Ca(OH)₂ | | Slurry | PSD | | | |
|---|---|---|---|---|---|---|---|
| | quantity | pH | Viscosity | % <2 | % <1 | d₅₀ | pH |
| Trial | ppm | (feed) | mPa · s | μm | μm | [μm] | (product) |
| 1 (comparative) | 0 | 9.59 | 133 | 60.3 | 38.0 | 1.50 | 9.31 |
| 2 (inventive) | 300 | 11.82* | 108 | 59.0 | 37.1 | 1.55 | 10.48** |

*after step b) of the process according to the invention
**after step c) of the process according to the invention

TABLE 3B
Specific grinding energies (SGE)

| | SGE | SGE improvement (reduction) |
|---|---|---|
| Trial | kWh/T_{dry} | % |
| 1 (comparative) | 68 | / |
| 2 (inventive) | 64 | −5.9 |

### Second Pass Wet Grinding

In a subsequent stage, the aqueous suspensions set out in Table 3A were wet ground once again in a 200-litre vertical attritor mill using zircon silicate beads of 0.3 to 0.7 mm diameter. Dispersing agent B was injected at the bottom of the mill during grinding at 3000 and 2500 ppm content, as shown in table 4.

TABLE 4
Dispersing agents for second pass wet grinding of the aqueous
suspension comprising the wet ground calcium carbonate-
containing material obtained in trial 1 and trial 2

| | | | Dispersing agent |
|---|---|---|---|
| | | | quantity |
| Trial | Feed suspension | Dispersing agent | ppm |
| 3 (comparative) | Trial 1 | B | 3000 |
| 4 (comparative) | Trial 1 | B | 2500 |
| 5 (inventive) | Trial 2 | B | 3000 |
| 6 (inventive) | Trial 2 | B | 2500 |

In all cases, the slurry temperature at the mill inlet was 50° C. and at the outlet between 9° and 100° C. The mill parameters where adjusted in order to reach a particle size distribution of at least 90%<2 μm. The aim of these test trials was to study if grinding energies could also be improved on the second pass without adding any additional hydroxide base. Results for the freshly ground slurries are shown in tables 5A and 5B.

TABLE 5A
Wet grinding parameters of trials 3 to 6

| | Solids | Slurry | PSD | | | |
|---|---|---|---|---|---|---|
| | content | Viscosity | % < 2 | % < 1 | d₅₀ | pH |
| Trial | % | mPa · s | μm | μm | [μm] | (product) |
| 3 (comparative) | 77.8 | 175 | 89.8 | 61.2 | 0.74 | 9.26 |
| 4 (comparative) | 77.9 | 188 | 89.7 | 60.9 | 0.73 | 9.22 |
| 5 (inventive) | 77.6 | 161 | 90.0 | 60.4 | 0.75 | 9.87 |
| 6 (inventive) | 77.7 | 160 | 89.4 | 59.6 | 0.76 | 9.86 |

TABLE 5B
Specific grinding energies (SGE)

| | | SGE improvement |
|---|---|---|
| | SGE | (reduction) |
| Trial | kWh/T_{dry} | % |
| 3 (comparative) | 73 | / |
| 4 (comparative) | 78 | +6.8 |
| 5 (inventive) | 70 | −4.1 |
| 6 (inventive) | 70 | −4.1 |

From tables 3A, 3B, 5A and 5B, it can be gathered that the specific grinding energy required for first and second pass wet grinding of an aqueous suspension comprising a calcium carbonate-containing material by a process according to the invention is reduced compared to a comparative process in which no hydroxide base was added as wet grinding additive under otherwise identical conditions.

### 2. Trials 7 to 17

### First Pass Wet Grinding

Several aqueous suspensions having solids content of 76 wt.-% (+/−1 wt-%) and a particle size distribution of at least 60%<2 μm were prepared by wet grinding in a vertical attritor mill as described in trial 1 above, i.e. without addition of a hydroxide base as wet grinding additive in this step.

### Second Pass Wet Grinding

Different hydroxide bases were then added to the aforementioned suspensions in form of 3 to 5 wt. % aqueous solutions/suspensions (depending on solubility of hydroxide base). Each suspension was afterwards wet ground once again in a 200-litre vertical attritor mill using zircon silicate beads of 0.3 to 0.7 mm diameter. Various amounts of dispersing agents were injected at the bottom of the mill during grinding. In all trials, the mill parameters where adjusted in order to reach a particle size distribution of at least 90%<2 μm, and the slurry temperature at the mill inlet was 50° C. and at the outlet between 9° and 100° C. Variable trial parameters are described in table 6 below.

TABLE 6
Hydroxide bases and dispersing agents for second
pass wet grinding of an aqueous suspension comprising
a calcium carbonate-containing material

| | | Hydroxide | Dispersing | Dispersing |
|---|---|---|---|---|
| | | base | agent | agent |
| | Hydroxide | quantity | injected in | quantity |
| Trial | base | ppm | 2^{nd} pass | ppm |
| 4 (comparative) | None | 0 | B | 2500 |
| 7 (inventive) | NaOH | 140 | B | 2500 |
| 8 (inventive) | Ca(OH)₂ | 200 | B | 2500 |
| 9 (inventive) | Mg(OH)₂ | 160 | B | 2500 |
| 10 (inventive) | Ca(OH)₂ | 75 | B | 2500 |
| 11 (inventive) | Ca(OH)₂ | 100 | B | 2500 |
| 12 (inventive) | Ca(OH)₂ | 300 | B | 2500 |
| 13 (inventive) | Ca(OH)₂ | 500 | B | 2500 |
| 14 (comparative) | None | 0 | C | 3000 |
| 15 (comparative) | None | 0 | D | 3000 |
| 16 (inventive) | Ca(OH)₂ | 300 | C | 3000 |
| 17 (inventive) | Ca(OH)₂ | 300 | D | 3000 |

In trials 7 to 9, different hydroxide bases were tested with amounts of dispersing agent B injected at the bottom of the mill during grinding. Results are described in tables 7A and 7B.

TABLE 7A
Wet grinding of an aqueous suspension comprising a calcium carbonate-containing
material in the presence of different hydroxides as wet grinding additive

| | | Solids | Slurry | PSD | | | |
|---|---|---|---|---|---|---|---|
| | pH | content | Viscosity | % <2 | % <1 | d₅₀ | pH |
| Trial | (feed) | % | mPa · s | μm | μm | [μm] | (product) |
| 4 (comparative) | 9.31 | 77.9 | 188 | 89.7 | 60.9 | 0.73 | 9.22 |
| 7 (inventive) | 10.05* | 77.6 | 166 | 90.3 | 60.4 | 0.74 | 9.63 |
| 8 (inventive) | 10.05* | 77.8 | 150 | 88.0 | 57.5 | 0.81 | 9.61 |
| 9 (inventive) | 9.30* | 77.8 | 181 | 90.6 | 61.1 | 0.74 | 9.35 |

*after step b) of the process according to the invention

TABLE 7B
Specific grinding energies (SGE)

| | SGE | SGE improvement (reduction) |
|---|---|---|
| Trial | kWh/T_{dry} | % |
| 4 (comparative) | 78 | / |
| 7 (inventive) | 71 | −8.9 |
| 8 (inventive) | 64 | −17.9 |
| 9 (inventive) | 73 | −6.4 |

From tables 7A and 7B, it can be gathered that adding a hydroxide base as a wet grinding additive before the second pass wet grinding of an aqueous suspension comprising a calcium carbonate-containing material by the process according to the invention systematically reduces the required specific grinding energy, compared to a comparative process in which no hydroxide base was added as wet grinding additive under otherwise identical conditions. Calcium hydroxide provides the best results among the different hydroxide bases tested as wet grinding additives.

Trials 10 to 13 tested how the use of different amounts of Ca(OH)₂ as wet grinding additive affected the reduction of the specific grinding energy required to grind an aqueous suspension comprising calcium carbonate-containing material. The results indicate a preferred pH range for wet grinding (i.e. a range for the pH value of the aqueous suspension after step b) of the inventive process) and are described in tables 9 and 10.

TABLE 8
Wet grinding of a calcium carbonate-comprising material suspension
with different amounts of Ca(OH)₂ as wet grinding additives

| | | | SGE | Solids | Slurry | PSD | | |
|---|---|---|---|---|---|---|---|---|
| | pH | SGE | improvement | content | Viscosity | % <2 | % <1 | d₅₀ |
| Trial | (feed) | kWh/T_{dry} | % | % | mPa · s | μm | μm | [μm] |
| 4 (comparative) | 9.31 | 78 | / | 77.9 | 188 | 89.7 | 60.9 | 0.73 |
| 8 (inventive) | 10.05* | 64 | −17.9 | 77.8 | 150 | 88.0 | 57.5 | 0.81 |
| 10 (inventive) | 9.66* | 71 | −9.0 | 78.0 | 167 | 90.8 | 60.7 | 0.75 |
| 11 (inventive) | 9.72* | 65 | −16.7 | 77.8 | 164 | 90.3 | 60.2 | 0.76 |
| 12 (inventive) | 10.63* | 65 | −16.7 | 77.8 | 167 | 90.7 | 61.0 | 0.74 |
| 13 (inventive) | 11.55* | 68 | −12.8 | 78.2 | 160 | 88.3 | 60.7 | 0.73 |

*after step b) of the process according to the invention.

The results presented in table 8 show that adding a hydroxide base to the aqueous suspension for increasing the pH value to a range between above 9.6 to 11.6 reduces the specific grinding energy compared to a comparative process in which no hydroxide base was added as wet grinding additive under otherwise identical conditions.

Trials 14 to 17 tested the use of different dispersing agents in combination with Ca(OH)₂, again injected at the bottom of the mill during grinding. Results are described in tables 9A and 9B.

TABLE 9A
Wet grinding of an aqueous suspension comprising a calcium carbonate-
containing material and different dispersing agents in the presence
or absence of a hydroxide base as wet grinding additive

| | | Solids | Slurry | PSD | | | |
|---|---|---|---|---|---|---|---|
| | pH | content | Viscosity | % <2 | % <1 | d₅₀ | pH |
| Trial | (feed) | % | mPa · s | μm | μm | [μm] | (product) |
| 14 (comparative) | 9.32 | 77.7 | 185 | 91.7 | 63.1 | 0.69 | 9.63 |
| 15 (comparative) | 9.32 | 77.4 | 220 | 92.3 | 63.5 | 0.69 | 9.72 |
| 16 (inventive) | 11.08* | 77.5 | 188 | 91.5 | 62.5 | 0.72 | 10.34 |
| 17 (inventive) | 11.08* | 77.7 | 220 | 92.2 | 63.1 | 0.71 | 10.41 |

*after step b) of the process according to the invention.

TABLE 9B
Specific grinding energies (SGE)

| | SGE | SGE improvement |
|---|---|---|
| Trial | kWh/T_{dry} | % |
| 14 (comparative) | 81 | / |
| 15 (comparative) | 75 | / |
| 16 (inventive) | 77 | −4.9 |
| 17 (inventive) | 72 | −4.0 |

Tables 9A and 9B show that the specific grinding energy is also reduced when adding the dispersing agents C and D instead of dispersing agent B for the second pass wet grinding step.

### 3. Trials 18 to 23

### First Pass Wet Grinding

An aqueous suspension with solids content of 76 wt.-% (+/−1 wt.-%) and a particle size distribution of at least 60%<2 μm was prepared by wet grinding in a vertical attritor mill as described in trial 1 above, i.e. without the addition of hydroxide base as wet grinding additive in this step.

### Second Pass Wet Grinding

300 ppm of Ca(OH) 2 was then added to the aforementioned suspension in form of a 3 to 5 wt. % aqueous suspension. Each suspension was afterwards wet ground once again in a 200-litre vertical attritor mill using zircon silicate beads of 0.3 to 0.7 mm diameter. The slurry temperature at the mill inlet was 50° C. and at the outlet between 9° and 100° C. The mill parameters where adjusted in order to reach a particle size distribution of at least 77%<1 μm, with various amounts of dispersing agent B injected at the bottom of the mill during grinding, as described table 10. Results are described in tables 11A and 11B.

TABLE 10
Wet grinding of an aqueous suspension comprising calcium
carbonate-containing material and different amounts
of dispersing agent in the presence or absence of
a hydroxide base as wet grinding additive

| | | | Dispersing | Dispersing |
|---|---|---|---|---|
| | | Hydroxide | agent | agent |
| | Hydroxide | base quantity | injected in | quantity |
| Trial | base | ppm | 2^{nd} pass | ppm |
| 18 (comparative) | None | 0 | B | 5000 |
| 19 (comparative) | None | 0 | B | 5500 |
| 20 (comparative) | None | 0 | B | 6000 |
| 21 (inventive) | Ca(OH)₂ | 300 | B | 5000 |
| 22 (inventive) | Ca(OH)₂ | 300 | B | 5500 |
| 23 (inventive) | Ca(OH)₂ | 300 | B | 6000 |

TABLE 11A

| | | Solids | Slurry | PSD | | | |
|---|---|---|---|---|---|---|---|
| | pH | content | Viscosity | % <2 | % <1 | d₅₀ | pH |
| Trial | (feed) | % | mPa · s | μm | μm | [μm] | (product) |
| 18 (comparative) | 9.38 | 77.5 | 303 | 97.6 | 78.3 | 0.51 | 9.08 |
| 19 (comparative) | 9.38 | 77.6 | 302 | 97.3 | 78.8 | 0.51 | 9.05 |
| 20 (comparative) | 9.38 | 78.0 | 279 | 97.0 | 76.5 | 0.53 | 9.09 |
| 21 (inventive) | 10.52* | 77.9 | 296 | 97.7 | 77.5 | 0.53 | 9.50 |
| 22 (inventive) | 10.52* | 78.0 | 271 | 97.0 | 77.3 | 0.52 | 9.51 |
| 23 (inventive) | 10.52* | 78.0 | 284 | 97.3 | 77.5 | 0.52 | 9.49 |

*after step b) of the process according to the invention.

TABLE 11B
specific grinding energies (SGE)

| | SGE | SGE improvement |
|---|---|---|
| Trial | kWh/T_{dry} | % |
| 18 (comparative) | 157 | / |
| 19 (comparative) | 149 | / |
| 20 (comparative) | 142 | / |
| 21 (inventive) | 136 | −13.3 |
| 22 (inventive) | 130 | −12.8 |
| 23 (inventive) | 130 | −8.5 |

Tables 11A and 11B show that the advantageous effects of the process according to the invention are also achieved when wet grinding the calcium carbonate-containing material to a very fine particle size distribution such that 77% by weight of particles have a particle size below 1 μm.

### 3. Trials 24 to 26

### Makedown Preparation

An aqueous suspension having solids content of 77 wt.-% (+/−1 wt.-%), based on the total weight of the suspension, was prepared by mixing tap water with 1500 ppm of dispersing agent A, 5500 ppm of dispersing agent B, 700 ppm of dispersing agent D, and the calcium carbonate-containing material B using a high-shear vertical mixer (Disperlux TD100, Pendraulik, Germany).

The resulting aqueous suspension was then split into 2 halves. The first half was retained for use in trial 24. The second half of the suspension had 200 ppm of Ca(OH) 2 added as a wet grinding additive, for use in trial 25. The Ca(OH) 2 was added so as to have a homogenous pH increase throughout the aqueous suspension.

Another aqueous suspension having solids content of 77 wt.-% (+/−1 wt.-%), based on the total weight of the suspension, was subsequently prepared by mixing tap water with 1500 ppm of dispersing agent A, 5500 ppm of dispersing agent B, 700 ppm of dispersing agent D, and the calcium carbonate-containing material B using a high-shear vertical mixer (Disperlux TD100, Pendraulik, Germany). This suspension then had 600 ppm of Ca(OH) 2 added as a wet grinding additive, for use in trial 26.

Table 12 describes the properties of all three suspensions, with and without the added wet grinding additive.

TABLE 12
Properties of an aqueous suspension feed comprising calcium
carbonate-containing material in the presence or absence
of a hydroxide base as wet grinding additive

| | | Hydroxide | | | |
|---|---|---|---|---|---|
| | | base | Solid | | |
| | Hydroxide | quantity | content | pH | Viscosity |
| Trial | base | ppm | % wt | (feed) | mPa · s |
| 24 (comparative) | None | 0 | 77.1% | 8.62 | 346 |
| 25 (comparative) | Ca(OH)₂ | 200 | 77.1% | 9.69* | 377 |
| 26 (inventive) | Ca(OH)₂ | 600 | 77.5% | 11.39* | 244 |

*after step b) of the process according to the invention

### Wet Grinding

Each mixture was then wet ground in a 6-litre batch horizontal attritor mill using zircon silicate beads of 0.7 to 1.4 mm diameter. The mill parameters where adjusted in order to reach a particle size distribution d50=0.6±0.1 μm. pH and particle size distribution values were taken throughout the trial to determine impact on the grinding efficiency. Results are shown in table 13A and 13B.

TABLE 13A
Wet grinding of an aqueous suspension comprising calcium carbonate-containing
material B in the presence or absence of Ca(OH)₂ as wet grinding additive

| | PSD | | Stable | | | | |
|---|---|---|---|---|---|---|---|
| | (feed) | Grinding | Grinding | PSD | | | Solid |
| | d₅₀ | time | temperature | (product) ** | pH | Viscosity | content |
| Trial | (μm) | min | ° C. | d₅₀ (μm) | (product) ** | mPa · s | % wt |
| 24 (comparative) | 5.3 | 80 | 64 | 0.6 | 9.00 | 320 | 77.4% |
| 25 (comparative) | 5.3 | 80 | 73 | 0.6 | 9.13 | 383 | 77.4% |
| 26 (inventive) | 5.4 | 75 | 64 | 0.7 | 9.65 | 278 | 77.6% |

** after step c) of the process according to the invention

Table 13A shows that addition of no calcium hydroxide in trial 24 provides as a product an aqueous suspension having a pH value of 9.00. Addition of 200 ppm of calcium hydroxide in trial 25 provides as a product an aqueous suspension having a pH value of 9.13. In trials 24 and 25, the pH values were almost identical after 30 min grinding time, i.e. both trials reached an almost identical equilibrium pH after 30 min grinding time.

Without wishing to be bound by theory, the inventors believe that, with an insufficient amount of hydroxide as wet grinding additive (as shown in trial 25), all additional hydroxide ions from the additive react with the dispersing agent and/or the fresh crystal surfaces of the ground mineral, to reach a similar pH as is obtained by grinding the aqueous suspension in the absence of the wet grinding additive (as demonstrated by trial 24). This equilibrium pH can depend on the nature of the mineral (marble or limestone, for instance), the nature of the dispersing agent, and the particle size distribution (which determines the surface available for reaction with hydroxide ions).

In trial 26, a sufficient excess of hydroxide ions is present to adjust the pH according to one embodiment of the present invention. The pH value remains above 9.5 in trial 26.

TABLE 13B
pH and PSD properties of the aqueous suspension after
20 min grinding of an aqueous suspension comprising
calcium carbonate-containing material B in the presence or
absence of Ca(OH)₂ as wet grinding additive

| | pH after 20 min | d50 (μm) after 20 min |
|---|---|---|
| Trial | grinding | grinding |
| 24 (comparative) | 8.85 | 2.2 |
| 25 (comparative) | 9.08 | 2.1 |
| 26 (inventive) | 9.76 | 1.7 |

Table 13B shows that improved grinding efficiency can be achieved when adding a sufficient amount of calcium hydroxide as “wet grinding booster” to adjust the pH values as described herein. However, if the amount of calcium hydroxide is insufficient and the pH values are not adjusted as described herein, an improved grinding efficiency is not achieved.

The horizontal attritor mill used in trials 24 to 26 works in batch mode. Given that other parameters are kept constant, the particle size distribution (PSD) at a defined grinding time is a good indicator of grinding efficiency for horizontal attritor batch mills. Table 13B shows that after 20 min of grinding, the particle size distribution d₅₀ of trials 24 and 25 are very similar, despite the addition of 200 ppm of calcium hydroxide in trial 25. Trial 26, on the other hand, shows a much finer particle size distribution d₅₀ for the product after 20 min grinding. The finer particle size after the same grinding time clearly indicates a better grinding efficiency in trial 26.

The example trials provided herein show that an improved grinding efficiency (“wet grinding booster effect”) can be achieved, when adjusting the pH values in the process as defined herein above and/or according to the claims.

Information on the quantity of calcium hydroxide which is added to an aqueous suspension is typically not sufficient on its own to determine whether or not an improvement of grinding efficiency can be achieved. For example, trial 8 (inventive) uses the same amount of calcium hydroxide as wet grinding additive and similar amount of dispersant as trial 25, but used a different mineral as starting material and ground to a different final particle size distribution. Unlike trial 25, trial 8 did show a significant SGE improvement during grinding and a pH value of the product was higher by 0.39 compared to Trial 4 (comparative), a similar aqueous suspension prepared in the same conditions, but without any hydroxide added as wet grinding additive.

1. A process for preparing a wet ground mineral material comprising the steps of:
a) providing an aqueous suspension comprising a mineral material, wherein the aqueous suspension has a pH value of equal to or above 8.0;
b) adding at least one hydroxide base to the aqueous suspension provided in step a);
c) wet grinding the aqueous suspension during and/or after step b) to obtain an aqueous suspension comprising a wet ground mineral material,
wherein the wet grinding is carried out in the presence of at least one dispersing agent,
wherein the pH value of the aqueous suspension provided in step a) is increased in step b) to a value in the range of above 9.60 to 11.90,
wherein the aqueous suspension obtained in step c) has a pH value which is at least 0.10 above the pH value of a comparative aqueous suspension which is obtained by the same process but without carrying out step b), and
wherein the aqueous suspension obtained in step c) has a pH value of equal to or above 9.30.

2. The process according to claim 1, wherein the mineral material is a magnesium carbonate- and/or calcium carbonate-containing material.

3. The process according to claim 1, wherein the aqueous suspension provided in step a) has a solids content of at least 10.0 wt. % based on the total weight of the aqueous suspension.

4. The process according to claim 1, wherein the aqueous suspension provided in step a) comprises at least one dispersing agent which is present during the wet grinding step c).

5. The process according to claim 1, wherein the pH value of the aqueous suspension provided in step a) is increased in step b) to a value in the range of 9.70 to 11.60.

6. The process according to claim 1, wherein the aqueous suspension obtained in step c) has a pH value which is at least 0.20 above the pH value of a comparative aqueous suspension which is obtained by the same process but without carrying out step b).

7. The process according to claim 1, wherein the at least one hydroxide base added in step b) is at least one hydroxide of a mono-, di- or trivalent metal cation.

8. The process according to claim 1, wherein the at least one hydroxide base added in step b) is calcium hydroxide, optionally in combination with another hydroxide base.

9. The process according to claim 1, wherein the at least one hydroxide base is added in step b) in an amount in the range of 25 to 1000 ppm, wherein “ppm” is defined as parts of at least one hydroxide base per million parts of dry mineral material.

10. The process according to claim 1, wherein the at least one dispersing agent is at least one ionic dispersing agent.

11. The process according to claim 1, wherein the at least one dispersing agent is at least one polymer comprising a repeating unit derived from a monomer selected from the group consisting of acrylic acid, methacrylic acid, maleic acid, maleic anhydrides, and salts thereof.

12. The process according to claim 1, wherein the at least one dispersing agent is present in wet grinding step c) an amount of at least 0.1 wt. % based on the total dry weight of the mineral material.

13. The process according to claim 1 any one of the preceding claims, wherein the at least one dispersing agent is added before, during and/or after step b).

14. The process according to claim 1, wherein the wet ground mineral material obtained in step c) has one or both of the following properties:
(i) a weight-median particle size d₅₀ in the range of 0.1 to 5.0 microns,
(ii) a weight-based top cut particle size d₉₈ in the range of 0.5 to 20 microns.

15. A process for reducing the specific grinding energy in wet grinding of an aqueous suspension comprising the step of:
introducing at least one hydroxide base to the aqueous suspension,
wherein the aqueous suspension comprises a mineral material and at least one dispersing agent.

16. The process according to claim 1, wherein the mineral material is a calcium carbonate containing material having a calcium carbonate content of at least 50.0 wt. %, based on the total weight of the calcium carbonate-containing material.

17. The process according to claim 1, wherein the aqueous suspension provided in step a) has a solids content of at least 75.0 wt. %, based on the total weight of the aqueous suspension.

18. The process according to claim 1, wherein the at least one hydroxide base added in step b) is selected from the group consisting of lithium hydroxide, sodium hydroxide, potassium hydroxide, magnesium hydroxide, calcium hydroxide, and mixtures thereof.

19. The process according to claim 1, wherein the at least one hydroxide base is added in step b) in an amount in the range of 100 to 700 ppm, wherein “ppm” is defined as parts of at least one hydroxide base per million parts of dry mineral material.

20. The process according to claim 1, wherein the at least one dispersing agent is added before step b).
